(19) United States
(12) Patent Application Publication
(10) Pub. No.: US 2003/0193413 A1
(43) Pub. Date: Oct. 16, 2003

(54) Business methods for notification systems

(76) Inventor: M. Kelly Jones, Delray Beach, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/435,770

(22) Filed: May 12, 2003

Related U.S. Application Data
(63) Continuation-in-part of application No. 10/300,460, filed on Nov. 20, 2002.
Application No. 10/300,460 is a continuation of application No. 09/395,501, filed on Sep. 14, 1999, now Pat. No. 6,486,801.
Application No. 09/395,501 is a continuation-in-part of application No. 09/163,588, filed on Sep. 30, 1998.
Application No. 09/395,501 is a continuation-in-part of application No. 08/852,119, filed on May 6, 1997.
Application No. 08/852,119 is a continuation of application No. 08/434,049, filed on May 2, 1995, now Pat. No. 5,623,260.
Application No. 08/852,119 is a continuation of application No. 08/432,898, filed on May 2, 1995, now Pat. No. 5,657,010.
Application No. 08/852,119 is a continuation of application No. 08/432,666, filed on May 2, 1995, now Pat. No. 5,668,543.
Application No. 08/407,319 is a continuation-in-part of application No. 08/063,533, filed on May 18, 1993, now Pat. No. 5,400,020.
(60) Provisional application No. 60/039,925, filed on Mar. 10, 1997.
(60) Provisional application No. 60/122,482, filed on Mar. 1, 1999.

(51) Int. Cl. G08G 1/123

(52) U.S. Cl. 340/994

(57) ABSTRACT

Business methods for notification systems are provided. One such method, among others, can be summarized by the following steps: offering to a user a notification service regarding status of travel of a movable thing relative to a location; charging a fee to the user in exchange for the notification service; in accordance with the notification service: (a) enabling the user to define at least two communications methods for receiving notifications relating to travel of a mobile thing; (b) enabling the user to define one or more criteria when each of the communications methods should be used as opposed to the one or more others; (c) monitoring travel data associated with the movable thing; and (d) providing a notification to the user using at least one of the communications methods based upon a particular proximity of the movable thing to the location and the one or more criteria.

### CLAIM OF PRIORITY

This application is a continuation-in-part of application Ser. No. 10/300,460, filed Nov. 20, 2002, which is a continuation of application Ser. No. 09/395,501, filed Sep. 14, 1999, now U.S. Pat. No. 6,486,801, which is a continuation-in-part of application Ser. No. 09/163,588 filed on Sep. 30, 1998, and a continuation-in-part of application Ser. No. 08/852,119 filed on May 6, 1997, which is a continuation of application Ser. No. 08/434,049, filed on May 2, 1995, now U.S. Pat. No. 5,623,260, and a continuation of application Ser. No. 08/432,898, filed May 2, 1995, now U.S. Pat. No. 5,647,010, and a continuation of application Ser. No. 08/432,666, filed on May 2, 1995, now U.S. Pat. No. 5,668,543, said application Ser. No. 08/434,049, is a continuation-in-part of application Ser. No. 08/407,319, filed on Mar. 20, 1995, now abandoned, which is a continuation-in-part of application Ser. No. 08/063,533, filed May 18, 1993, now U.S. Pat. No. 5,400,020, said application Ser. No. 08/432,898, is a continuation-in-part of application Ser. No. 08/407,319, which is a continuation-in-part of application Ser. No. 08/063,533, said application Ser. No. 08/432,666, is a continuation-in-part of application Ser. No. 08/407,319, which is a continuation-in-part of application Ser. No. 08/063,533, said application Ser. No. 08/852,119 claims priority to provisional application No. 60/039,925, filed on Mar. 7, 1997 and said application Ser. No. 09/395,501 claims priority to provisional application No. 60/122,482, filed on Mar. 1, 1999. All of the foregoing applications and patent documents are incorporated herein by reference in their entirety.

### BACKGROUND OF THE INVENTION

1. Field of the Invention

The present invention generally relates to data communications and information systems and, more particularly, to business methods for notification systems for notifying users of travel status of movable things.

2. Related Art

For at least the purposes of allowing better preparation and scheduling, for example, with respect to pickups or deliveries, it would be desirable to know, with substantial accuracy, the expected arrival or departure time of a mobile vehicle or thing (for example but not limited to, a bus, automobile, truck, train, ship, plane, aircraft, etc.) with respect to a location.

For example, consider a commercial bus service. A person intending to catch a bus or intending to pick up a friend or relative at the commercial bus station usually calls the bus station to find out the approximate arrival time (information which is oftentimes unavailable or unreliable) and/or arrives at the bus station prior to the scheduled arrival or departure time of the bus, hoping that the bus is not significantly delayed. With knowledge of accurate arrival or departure information, adjustments can be made to one's schedule to avoid having to wait extended periods for a vehicle.

Another example involves school children that ride school buses. The arrival times of school buses at scheduled stops can be significantly affected by many factors, such as maintenance problems, rush hour traffic, congested urban/suburban conditions, and adverse weather. As a result, school children typically wait at bus stops for long periods of time, oftentimes in adverse weather conditions, on unlit street corners, or in hazardous conditions near busy or secluded streets. An advance notification system that would inform the students of the school bus's proximity would be desirable so that students can avoid having to wait for the school bus at the bus stop for extended time periods.

Yet another example involves the commercial overnight package industry, wherein packages are delivered or picked up many times on a tight schedule. Customers oftentimes wait on delivery or pickup of important time-critical packages, not knowing precisely when the delivery or pickup will occur. An advance notification system that can inform a customer of the precise arrival or departure time of a delivery vehicle with respect to a location would be desirable in order to improve customer service and to allow the customer to better schedule a delivery or pickup of an item.

### SUMMARY OF THE INVENTION

Briefly described, the present invention provides business methods for notification systems. One such method, among others, can be summarized by the following steps: offering to a user a notification service regarding status of travel of a movable thing relative to a location; charging a fee to the user in exchange for the notification service; in accordance with the notification service: (a) enabling the user to define at least two communications methods for receiving notifications relating to travel of a mobile thing; (b) enabling the user to define one or more criteria when each of the communications methods should be used as opposed to the one or more others; (c) monitoring travel data associated with the movable thing; and (d) providing a notification to the user using at least one of the communications methods based upon a particular proximity of the movable thing to the location and the one or more criteria.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating an exemplary implementation of a vehicle tracking system employed within the context of an advance notification.

FIG. 2 is a block diagram illustrating an exemplary implementation of the vehicle control unit of FIG. 1.

FIG. 3 is a block diagram illustrating an exemplary implementation of a computer implementing the functionality of the vehicle manager of FIG. 1.

FIG. 4 is a block diagram illustrating an exemplary implementation of a computer implementing the functionality of the base station manager of FIG. 1.

FIG. 5 is a flow chart illustrating an exemplary implementation of at least part of the architecture, functionality, and operation of the vehicle control unit of FIG. 2 while the vehicle control unit is creating the vehicle schedule of FIG. 3.

FIG. 6 is a flow chart illustrating an exemplary implementation of at least part of the architecture, functionality, and operation of the vehicle control unit of FIG. 2 while the vehicle control unit is tracking the vehicle of FIG. 1.

FIG. 7 is a flow chart illustrating an exemplary implementation of at least part of the architecture, functionality, and operation of the base station manager of FIG. 1 for implementing a user-definable communications method.

FIG. 8 is a possible computer screen that can be used in connection with the first user-definable communications method of FIG. 7.

FIG. 9 is a flow chart illustrating an exemplary implementation of at least part of the architecture, functionality, and operation of the base station manager of FIG. 1 for implementing another user-definable communications method.

FIG. 10 is a possible computer screen that can be used in connection with the second user-definable communications method of FIG. 9.

FIG. 11 is a flow chart illustrating an exemplary implementation of at least part of the architecture, functionality, and operation of the base station manager of FIG. 1 for implementing yet another user-definable communications method.

### DETAILED DESCRIPTION OF THE INVENTION

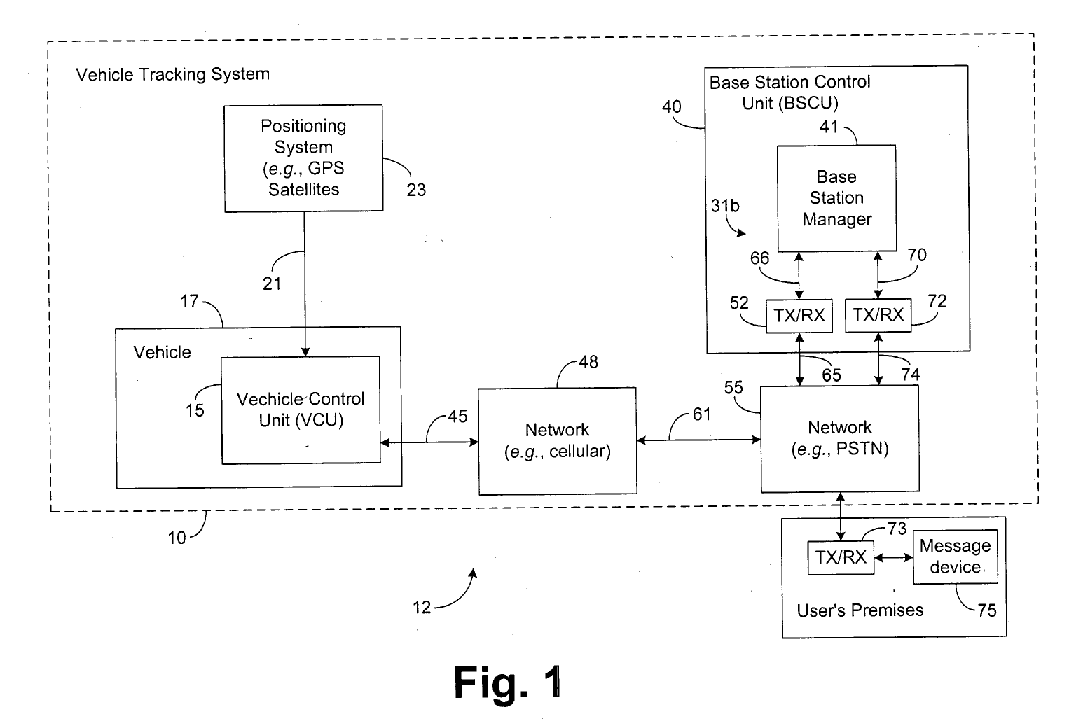

FIG. 1 depicts an automated vehicle tracking system 10 illustrating a possible context, among others, in which the present invention may be implemented. As shown by FIG. 1, the vehicle tracking system 10 is preferably employed within the context of an automated advance notification system 12 that automatically provides advance notice of impending arrivals of vehicles at destinations or other locations. However, it is possible to utilize the vehicle tracking system 10 independent of the notification system 12 in applications where the transmission of a notification message (which will be described in further detail hereinafter) is not desired.

As depicted in FIG. 1, a vehicle control unit (VCU) 15 is disposed on a mobile vehicle 17, which is capable of transporting the VCU 15 over various distances. For example, vehicle 17 can be any movable object or thing, including but not limited to, an automobile, an airplane, a train, a boat, a human being, an animal, or any other thing capable of moving across or through the Earth's surface and/or atmosphere.

In the preferred embodiment, the vehicle 17 is a delivery vehicle for delivering items to a destination or for picking up items at a destination. Please note that items can include many various types of packages or goods to be delivered or picked up. Furthermore, items can also include persons to be picked up or delivered, such as when a bus picks up and/or delivers passengers at different bus stops or such as when an airplane picks up and/or delivers passengers at airports. Preferably, although not necessarily, the vehicle 17 travels along a predetermined route in making its deliveries, and the vehicle 17 may make one or more stops along its route in order to deliver or pick up different items at different locations.

Vehicle Control Unit

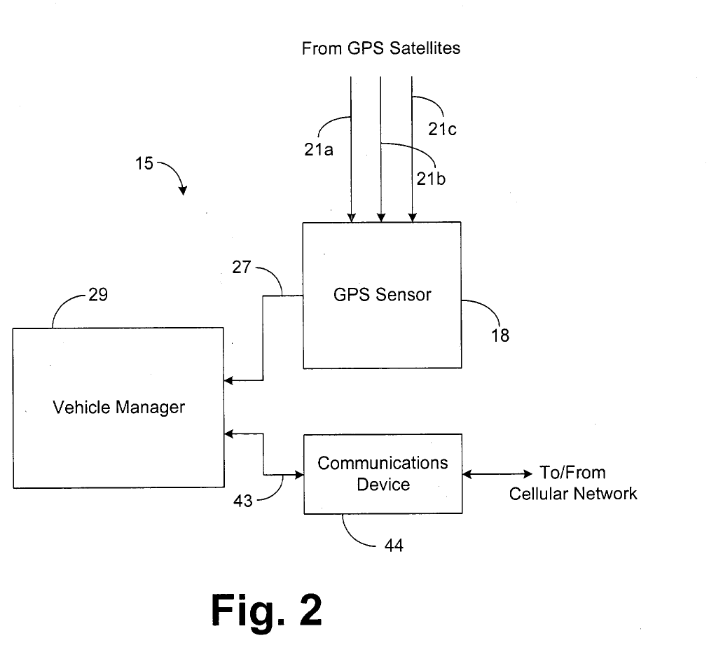

A more detailed view of the exemplary VCU 15 is depicted in FIG. 2. A sensor 18 within VCU 15 is configured to determine the location of the sensor 18 relative to a predetermined reference point. In the preferred embodiment, sensor 18 is a global positioning system (GPS) sensor, although other types of positioning systems and/or sensors are also possible. For example, other types of sensors 18 that may be used to implement the principles of the present invention include, but are not limited to, sensors 18 associated with GLONASS, LORAN, Shoran, Decca, TACAN, radar, traffic system monitoring, or any other of numerous possible tracking systems. The GPS sensor 18 of the preferred embodiment is configured to receive signals 21 from a plurality of GPS satellites 23, and as known in the art, sensor 18 is designed to analyze signals 21 in order to determine the sensor's location or coordinate values relative to a predetermined reference point. For example, in the preferred embodiment where sensor 18 is a GPS sensor, the sensor 18 determines the sensor's location values relative to the Earth's zero degree latitude and zero degree longitude reference point, which is located at the intersection of the Equator and the Prime Meridian. U.S. Pat. No. 5,781,156 entitled “GPS Receiver and Method for Processing GPS Signals” and filed on Apr. 23, 1997 by Krasner, which is incorporated herein by reference, discusses the processing of GPS signals 21 received from GPS satellites 23 in order to determine the sensor's location values. Since the sensor 18 is located within VCU 15, the location values determined by the sensor 18 are assumed to match the location values of the vehicle 17 and the VCU 15.

It should be noted that the term “location value” shall be defined herein to mean any value or set of values that may be used to determine a location of a point on the Earth or within the Earth's atmosphere. This value may be a coordinate value (i.e., grid value), polar value, vector value, time-distance value, or any other type of value or values known in the art for indicating locations of points.

In alternative embodiments, the positioning system 23 may determine vehicle location information and merely transmit the position information to the vehicle 17. For example, radar could be used to remotely track the vehicle and then the rader system could be designed to convey vehicle position information to the vehicle 17 (or even the base station control unit (BSCU) 40, which will be described in detail hereinafter).

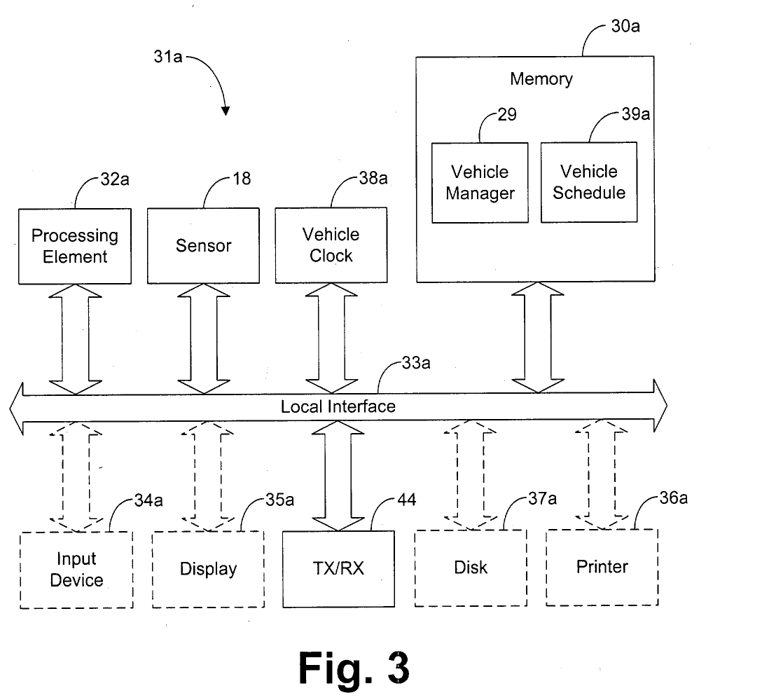

Sensor 18 is designed to transmit a signal 27 to vehicle manager 29 indicating the vehicle's current location values. Vehicle manager 29 is configured to receive signal 27 and to monitor the location of the vehicle 17 over time by processing multiple signals 27. The vehicle manager 29 can be implemented in software, hardware, or a combination thereof. In the preferred embodiment, as illustrated by way of example in FIG. 3, the vehicle manager 29 of the present invention along with its associated methodology is implemented in software and stored in computer memory 30a of a computer system 31a.

Note that the vehicle manager 29 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. As an example, the vehicle manager 29 may be magnetically stored and transported on a conventional portable computer diskette.

An exemplary embodiment of the computer system 31a of FIG. 3 comprises one or more conventional processing elements 32a, such as a microprocessors, digital signal processors (DSPs), or other suitable processing means, that communicate to and drive the other elements within the system 31a via a local interface 33a, which can include one or more buses. Furthermore, an input device 34a, for example, a keyboard or a mouse, can be used to input data from a user of the system 31a, and screen display 35a or a printer 36a can be used to output data to the user. A disk storage mechanism 37a can be connected to the local interface 33a to transfer data to and from a nonvolatile disk (e.g., magnetic, optical, etc.). It should be noted that input device 34a, display 35a, printer 36a, and disk 37a are optional and are not a part of the preferred embodiment, although other embodiments may include these features.

The vehicle manager 29 is preferably configured to maintain a predefined schedule 39a, referred to herein as the “vehicle schedule 39a,” within memory 30a. The predefined vehicle schedule 39a corresponds with a route of travel for the vehicle 17. In this regard, the predefined vehicle schedule 39a stored in memory 30a includes data defining locations along the vehicle's intended route of travel. Furthermore, each location is associated with a particular time value indicating when the vehicle 17 is expected to reach the associated location. Each time value along with its associated location defines an entry in the vehicle schedule 39a.

In the preferred embodiment, the time value corresponds to the estimated amount of time that should lapse between the time that the vehicle 17 starts its intended route and the time that the vehicle 17 reaches the associated location along the route. However, other time values may be used without departing from the principles of the present invention. For example, the time of day that the vehicle 17 is expected to reach the associated location may be used. Any time value that indicates when the vehicle 17 is expected to reach the associated location is sufficient for the purposes of the present invention. However, for illustrative purposes, the present invention will be discussed hereinafter assuming that the time values in the entries of the vehicle schedule 39a conform to the preferred embodiment (i.e., that the time values represent the amount of time that should lapse between the time that the vehicle 17 starts its intended route and the time that the vehicle 17 reaches the associated location along the route).

The vehicle manager 29 is configured to monitor the amount of time that lapses as the vehicle 17 travels along the vehicle's route. For example, the computer system 31a can include a clock 38a that indicates the time of day. In this situation, the vehicle manager 29 is configured to store the time value of the clock 38a when the vehicle 17 begins the route. Therefore, the vehicle manager 29 can determine the amount of time that has lapsed since the start of the route by comparing the current time value oft he clock 38a versus the stored time value for the start of the route. Alternatively, the clock 38a can be designed as a counter that begins timing or counting in response to a start signal transmitted by the vehicle manager 29. Therefore, the vehicle manager 29 transmits the start signal when the vehicle 17 starts the route, and thereafter, the vehicle manager 29 can determine the amount of time that has lapsed since the start of the route by analyzing the value of the clock 38a. Other devices and/or methodologies may be employed to determine the amount of time that has lapsed since the start of the route without departing from the principles of the present invention.

As the vehicle 17 travels along the predetermined route of travel, the vehicle manager 29 is configured to determine the vehicle's current position by analyzing the location values from the sensor 18. Furthermore, as the vehicle 17 travels, the vehicle 17 passes the points or locations along the route that are defined in the vehicle schedule 39a. The vehicle manager 29 is designed to compare the current location values of the vehicle 17 (i.e., of the sensor 18) with the location values defined by the vehicle schedule 39a in order to determine which entry in the vehicle schedule 39a corresponds with the current location of the vehicle 17. In the preferred embodiment, the entry that corresponds with the current location of the vehicle 17 is the entry having location values most closely matching the location values currently supplied by the sensor 18. In other words, the corresponding entry includes location values representing the location that is closest to the location of the vehicle 17. This entry will be referred to hereinafter as the “corresponding entry.”

After determining which entry corresponds with the current location of the vehicle 17, the vehicle manager 29 is designed to determine whether the vehicle 17 is off schedule or on schedule. The vehicle 17 is off schedule if the amount of time that has lapsed since the start of the route differs from an estimated lapsed time by a predetermined amount of time. In the preferred embodiment, the estimated lapsed time is represented by the time value in the corresponding entry of the vehicle schedule 39a. As an example, assume for illustrative purposes only that the predetermined amount of time is five minutes. If the vehicle manager 29 determines that the difference between the actual lapsed time since the start of the trip and the estimated lapsed time (i.e., the time value in the corresponding entry) is greater than five minutes, then the vehicle 17 is off schedule. Otherwise the vehicle 17 is on schedule.

Furthermore, if the vehicle 17 is off schedule, then the vehicle manager 29 is also designed to determine whether the vehicle 17 is early or late. If the actual time lapsed since the start of the trip is greater than the estimated lapsed time, then the vehicle 17 is late. If the actual time lapsed since the start of the trip is less than the estimated lapsed time, then the vehicle 17 is early.

Alternatively, the vehicle manager 29 can be configured to select the corresponding entry in the predefined schedule 39a via comparison of time values instead of location values. In this regard, the vehicle manager 29 can be configured to compare the current time value indicated by the clock 38a (e.g., the lapsed time since the start of the route) with the time values in the entries of the vehicle schedule 39a. The corresponding entry is then the entry in vehicle schedule 39a having the estimated time value that differs the least with the actual time value indicated by clock 38a.

In this situation, the vehicle manager 29 compares the current location values from sensor 18 with the location values associated with the corresponding entry of the vehicle schedule 39a in order to determine whether or not the vehicle 17 is on schedule. If the location values differ by more than a predefined threshold value, then the vehicle 17 is off schedule. Otherwise, the vehicle is on schedule. Furthermore, if the actual location of the vehicle 17 (as defined by the current location values from sensor 18) is further along the route of travel than the location associated with the corresponding entry (as defined by the location values in the corresponding entry), then the vehicle 17 is early. If the location associated with the corresponding entry (as defined by the location values in the corresponding entry) is further along the route of travel than the actual location of the vehicle 17 (as defined by the current location values from sensor 18), then the vehicle 17 is late.

In response to a determination by the vehicle manager 29 that the vehicle 17 is off schedule, the vehicle manager 29 is designed to transmit a status message to Base Station Control Unit (BSCU) 40 (FIG. 1), which is remotely located from the vehicle 17. The status message preferably indicates that vehicle 17 is off schedule and indicates the amount that vehicle 17 is off schedule. Co-pending U.S. patent application entitled “System and Method for Enciphering and Communicating Vehicle Tracking Information” filed by Jones, et al. on Sep. 30, 1998, and assigned Ser. No. 09/163,606, which is incorporated herein by reference, describes a system and method for transmitting messages to BSCU 40.

Transmission of a Status Message

BSCU 40 preferably includes a base station manager 41 designed to monitor the travel of each vehicle 17 associated with the system 10. In the preferred embodiment, unlike the VCU 15, the BSCU 40 is substantially non-mobile. As an example, the BSCU 40 can be located in a central office of a telephone company.

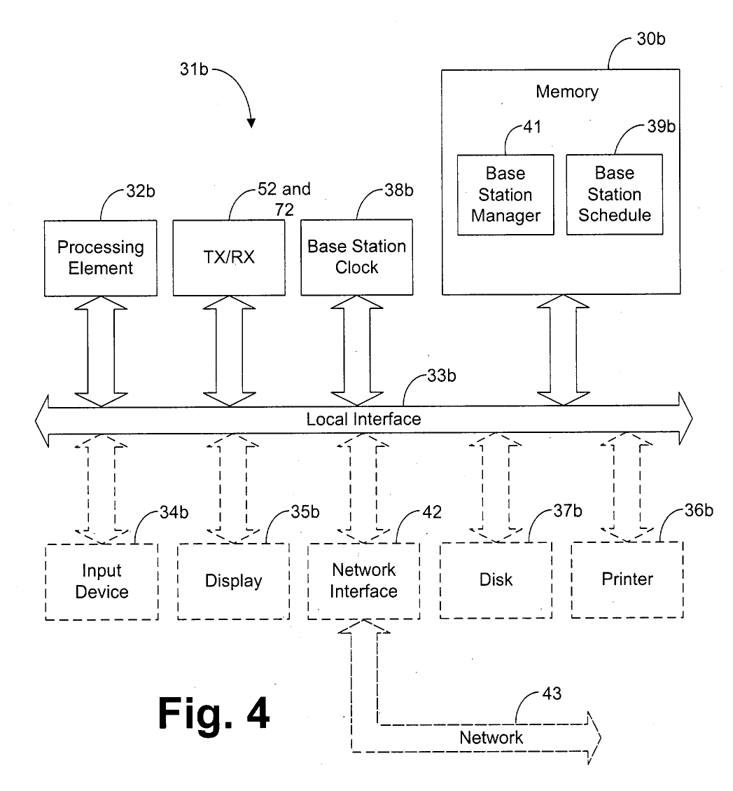

The base station manager 41 can be implemented in software, hardware, or a combination thereof. In the preferred embodiment, as illustrated by way of example in FIG. 4, the base station manager 41 of the present invention along with its associated methodology is implemented in software and stored in computer memory 30b of a computer system 31b. The computer system 31b can be similar to computer system 31a, as can be seen by comparing FIG. 3 to FIG. 4. In this regard, the computer system 31b may include memory 30b for storing the base station manager 41, and the computer system 31b may also include processing element 32b, local interface 33b, input 34b, display 35b, printer 36b, and storage disk 37b. It may also be desirable for computer system 31b to include a network interface 42 that allows the system 31b to exchange data with a network 43. It should be noted that input device 34b, display 35b, printer 36b, disk 37b, network interface 42, and network 43 are optional.

In order to transmit the status message to the BSCU 40, the vehicle manager 29 is configured to transmit the status message, via signal 43 (FIG. 2), to a communications device 44, which is capable of transmitting and receiving data to and from devices outside of vehicle 17. In this regard, communications device 44 is preferably, although not necessary, a cellular modem configured to transmit and receive wireless signals to and from a cellular network 48 (FIG. 1).

The communications device 44 can transmit the status message over the voice channels associated with the cellular network 48, as is done by most cellular modems of the prior art. However, in order to reduce the cost associated with transmitting the travel data through the cellular network 48, the status message may be communicated through the cellular network 48 via a data or control channel. In this regard, the status message can be encoded by altering identifiers of the communications device 44, such as the mobile identification number (MIN) or electronic serial number (ESN), transmitted over a data channel of the cellular network 48. Alternatively, the status message can be appended to a feature request transmitted over the data channel. U.S. Pat. No. 5,771,445 entitled “Data Messaging in a Communications Network using a Feature Request,” filed on Dec. 15, 1995, by Kennedy, III, et al., and U.S. Pat. No. 5,546,444 entitled “Methods and Apparatus for Communicating Data Via a Cellular Network Control Channel” filed on Mar. 11, 1994, by Roach, Jr., et al., which are both incorporated herein by reference, discuss the transmission of travel data over a data or control channel associated with the cellular network 48 in further detail.

In order to transmit the status message through a data channel by manipulating identifiers of the communications device 44, the MIN of the communications device 44 is altered to include the status message, but the ESN remains fixed to be used as an identifier of the communications device 44. Therefore, after transmitting the identifiers through the data channel, the communications device 44 can be identified by the ESN, and the status message can be determined from the MIN. Alternatively, the ESN of communications device 44 can be altered while the MIN is kept constant. It should be understood that the invention contemplates modification of the MIN, ESN, both the MIN and ESN, or other identifiers of the communications device 44 to accomplish the dual task of transmitting status messages and identifying the communications device 44.

Alternatively or in combination with the manipulation of the identifiers of the communications device 44, the status message can be communicated through the data channel by appending the status message to feature requests that are transmitted through the data channel. In this regard, most feature requests are generated by automatically or manually dialing the star key (“*”) followed by a two-digit feature request identification code, and 29 digits of data. Therefore, for each feature request generated, 29 digits of data pertaining to the status message can be appended to the two-digit feature request identification code and sent over the data channel of the cellular network 48. Other embodiments may transmit different amounts of data following the feature request. By utilizing the manipulation of identifiers or the appendage of travel data to feature requests, less data is transmitted through the voice channels of the cellular network 48, thereby reducing the cost of transmitting data through the cellular network 48.

In order for successful communication to exist between vehicle manager 29 and base station manager 41, both managers 29 and 41 should be aware of the communications protocol utilized. Therefore, it is desirable for the base station manager 41 or the vehicle manager 29 to initially transmit an instruction via the data channel of the cellular network 48 to the other manager 29 or 41 indicating the protocol to be utilized. Thereafter, the vehicle manager 29 transmits messages to the base station manager 41 via the selected protocol.

Cellular network 48 is designed to transmit the status message to a communications device 52 (FIG. 1) at the BSCU 40. Although not necessary for implementation of the present invention, cellular network 48 is preferably designed to transmit to the communications device 52 via a public switched telephone network (PSTN) 55. In this regard, PSTN 55 establishes a link between communications device 52 and cellular network 48, whereby cellular network 48 and communications device 52 can communicate via signals 61 and 65, which are transmitted over land-line connections in the preferred embodiment. Therefore, communications device 52 is preferably designed as a PSTN modem capable of communicating signals 65 between base station manager 41 and PSTN network 55.

Although the preferred embodiment utilizes a cellular network 48 and a PSTN network 55 to communicate travel data to base station manager 41, one ordinarily skilled in the art should realize that other configurations are possible. For example, communications device 52 can be configured as a cellular modem capable of communicating signals directly with cellular network 48. Alternatively, utilization of communications networks 48 and 55 can be completely circumvented by configuring the communications device 44 to communicate directly with communications device 52, for example. Any embodiment capable of communicating data between vehicle manager 29 and base station manager 41 should be suitable for implementing the principles of the present invention.

It should be noted that by transmitting a status message only when the vehicle 17 is off schedule reduces the cost of operating the system 10. In this regard, communication through a cellular network 48 is relatively expensive, and the cost is based on the amount of data transmitted. By refraining from transmitting any data from the vehicle manager 29 to the base station manager 41 when the vehicle 17 is on schedule, the amount of data transmitted through the cellular network 48 is reduced, thereby reducing the communications cost associated with the system 10. Therefore, the present invention's methodology of assuming the vehicle 17 is on schedule and of only transmitting data to the base station manager 41 when the vehicle 17 is off schedule enables the system 10 to minimize costs. It should be noted that the foregoing feature is optional.

Base Station Manager

Base station manager 41 is designed to monitor the travel of the vehicle 17 and (when employed in the context of advance notification system 12) is also designed to transmit a notification message to a user when the vehicle 17 is a predetermined proximity from a particular vehicle destination or other location. The predetermined proximity can be a particular time or distance that the vehicle 17 is from the destination. If the vehicle 17 is off schedule, then the base station manager 41 is further configured to transmit a message to the user indicating that the vehicle 17 is off schedule.

The base station manager 41 of tracking system 10 is designed to determine the current location of the vehicle 17 and to compare the current location of the vehicle 17 to a predefined location along the route of travel of the vehicle 17 in order to determine whether notification should be sent to the user. In this regard, like the vehicle manager 29, the base station manager 41 includes a predefined schedule 39b, referred herein as the “base station schedule 39b,” in memory 30b. Furthermore, similar to the computer system 31a (FIG. 3), the computer system 31b (FIG. 4) includes a clock 39b or other type of counter that can be used to determine the amount of time that has lapsed since the vehicle 17 started traveling along the vehicle's route. When the vehicle 17 begins the route, the vehicle manager 29 preferably transmits a message to the base station manager 41 via communications devices 44 and 52 indicating that travel on the route is beginning. In response, the base station manager 41, like the vehicle manager 29, begins monitoring the amount of time lapsed since the start of the route.

In the preferred embodiment, the base station schedule 39b stored in memory 30b matches the vehicle schedule 39a stored in memory 30a, although variations in the two predefined schedules 39a and 39b are possible. Furthermore, the base station manager 41 is configured to retrieve an entry, the “corresponding entry,” in the base station schedule 39b corresponding with the amount of time lapsed since the vehicle 17 began travelling its route. In this regard, the base station manager 41 compares the amount of time that has lapsed since the vehicle 17 began its route (as determined from the clock 38b at the BSCU 40) with the time values in the base station schedule 39b. The corresponding entry in the base station schedule 39b is the entry having the time value differing the least with the value indicated by the clock 38b (i.e., the time value indicating the amount of time that has lapsed since the vehicle 17 began its route).

The base station manager 41 assumes that the vehicle 17 is on schedule, unless the base station manager 41 has received a recent status message from the vehicle manager 29. As used herein, a “recent status message” is the most recent status message that has been received by the base station manager 41 within a predetermined time. For example, a recent status message could be the latest status message received within the last five minutes, or at the start of a route, or some other suitable time frame. Therefore, if the base station manager 41 has not received a recent status message from the vehicle manager 29, then the base station manager 41 assumes that the location values in the corresponding entry of the predefined base station schedule 39b indicate the current location of the vehicle 17.

Recalling that base station manager 41 (when employed within the context of notification system 12) is to transmit a notification message when the vehicle 17 is a predetermined proximity from a particular location (e.g., a vehicle stop), the base station manager 41 then compares the location values in the corresponding entry (which represent the current location of the vehicle 17) with location values defining the predetermined proximity. If the location values from the corresponding entry differ from the location values of the predetermined proximity by less than a predetermined amount, then the base station manager 41 transmits a notification message to the user. Otherwise no notification message is transmitted to the user.

Alternatively, the base station manager 41 can be configured to compare time values instead of location values in order to determine whether a notification message should be transmitted to the user. In this regard, the base station manager 41 is designed to compare the time value in the corresponding entry with a predetermined threshold value indicating the amount of time that should lapse between the vehicle 17 starting its route and arriving at a location associated with the predetermined proximity (e.g., a threshold value indicating how long the vehicle should travel along its route before notification should be sent to the user). If the threshold value in the corresponding entry exceeds the predetermined time value, then the base station 41 transmits a notification message to the user.

If the base station manager 41 of tracking system 10 has received a recent status message from the vehicle manager 29, then the base station manager 41 determines the actual location values of the vehicle 17 based on the location values in the corresponding entry and the recent status message. In this regard, the location values in the corresponding entry represent the estimated location of the vehicle 17. The status message indicates how much the vehicle 17 is off schedule (i.e., how far the vehicle 17 is from the estimated location). For example, the status message can indicate that the vehicle is five miles off schedule. Therefore, the base station manager 41 is designed to calculate new location values based on the estimated location and the status message. These new location values represent the actual location of the vehicle 17. Therefore, by using the new location values instead of the values in the corresponding entry, the base station manager 41 can determine whether a notification message should be sent to the user according to the methodology described hereinabove.

Furthermore, instead of indicating how far the vehicle is from the estimated location via location values, the status message can indicate how far the vehicle 17 is from the estimated location via a time value (e.g., the status message can indicate that the vehicle 17 is ten minutes late). In this case, the base station manager 41 is designed to adjust the time value in the corresponding entry to account for the vehicle 17 being off schedule. For example, if the vehicle 17 is early, then the time value in the corresponding entry is increased a corresponding amount, and if the vehicle 17 is late, then the time value in the corresponding entry is decreased a corresponding amount. This adjusted time value is then compared with the predetermined threshold value described hereinabove in order to determine whether notification should be sent. If the adjusted time exceeds the predetermined time value, then the base station 41 transmits a notification message to the user.

In an alternative embodiment, the location values transmitted in the status message can represent the actual location of the vehicle 17 instead of representing how far the vehicle 17 is off schedule. In this embodiment, the base station manager 41 can be designed to directly compare these location values with the location values defining the predetermined proximity in order to determine whether notification should be sent to the user. Accordingly, if these location values differ from the location values defining the predetermined proximity by less than a predetermined amount, then the base station manager 41 transmits a notification message to the user. Otherwise, no notification message is sent to the user.

Furthermore, when the base station manager 41 determines that the vehicle 17 is off schedule, the base station manager preferably transmits an off schedule message to the user, as described hereinbelow, to notify the user that the vehicle 17 is off schedule. This message can include a variety of information including, but not limited, how much (in time or distance) the vehicle 17 is off schedule. However, it should be noted that communication of the off schedule message is not a necessary feature of the present invention.

Transmission of Off Schedule and Notification Messages

Once the base station manager 41 of systems 10 and 12 determines that a notification or an off schedule message should be sent to a user, the base station manager 41 is designed to communicate the message to the user via PSTN network 55 and communications devices 72 and 73 (FIG. 1). In this regard, communications devices 72 and 73 are preferably PSTN modems capable of interfacing with and communicating with PSTN network 55. Base station manager 41 is designed to transmit the message as signal 70 to user communications device 72, which communicates the message with PTSN network 55 via signal 74. PTSN network 55 then communicates the message to communications device 73, which is preferably configured to communicate the message to a message device 75. Message device 75 is configured to notify the user of the message. Preferably, message device 75 is a computer capable of displaying the notification through e-mail or some other communications software. Alternatively, message device 75 can be a telephone, a pager or any other device capable of notifying the user. Furthermore, a plurality of communications devices 72 preferably exist so that the base station manager 41 can simultaneously notify a plurality of users or parties of the impending arrival of the vehicle 17 at the vehicle stop.

Although the preferred embodiment utilizes a PSTN network 55 to communicate a notification or an off schedule message to message device 75, one ordinarily skilled in the art should realize that other configurations are possible. For example, other communications networks can be utilized or utilization of communications networks can be completely circumvented by configuring communications device 72 to communicate directly with communications device 73. Any communications system capable of communicating data between base station manager 41 and message device 75 should be suitable for implementing the principles of the present invention.

As an example, the base station manager 41 may notify the user of the impending arrival of the vehicle 17 by transmitting a distinctive ring to the user's message device. In this embodiment, the message device 75 is a telephone ringer. A distinctive ring is a ringing cadence that is different than the standard ringing cadence used to notify the user of a telephone call. Since the user can different the different ringing cadence, the user is aware that the telephone call corresponds to a notification message from the base station manager 41 indicating that arrival of the vehicle 17 is imminent. A system for transmitting a distinctive telephone ring as the notification message is fully described in U.S. patent application entitled “Advance Notification System and Method Utilizing a Distinctive Telephone Ring,” assigned Ser. No. 08/762,052 and filed on Dec. 9, 1996, which is incorporated herein by reference.

Creation of the Vehicle and Base Station Schedules

It should be noted that the predefined vehicle schedule 39a and the predefined base station schedule 39b can be determined or defined by a variety of methodologies. For example, the predetermined schedules 39a and 39b can be estimated based on various factors, such as the types of speeds likely to be traveled by the vehicle 17 and the types of traffic conditions expected to be encountered during travel. However, in the preferred embodiment, the predefined schedules 39a and 39b are defined via a previous delivery of the vehicle 17 along the same route of travel.

In this regard, delivery vehicles 17 frequently travel the same routes. This is especially true for buses, for example, where a bus routinely travels the same route and makes the same stops. As the vehicle 17 is traveling the route, the vehicle manager 29 is configured to periodically read the sensor 18 and to store an entry in memory 30a. The entry preferably includes the current location values of the vehicle 17 indicated by sensor 18 and the time value indicated by clock 38a (i.e., the time value indicating the amount of time that has lapsed since the start of the travel on the route). Therefore, when the vehicle 17 reaches the end of the route, the vehicle manager 29 has stored numerous entries which define the predefined vehicle schedule 39a. This predefined schedule 39a may also be used as the base station schedule 39b. Other methodologies may be employed to define the vehicle schedule 39a and/or the base station schedule 39b.

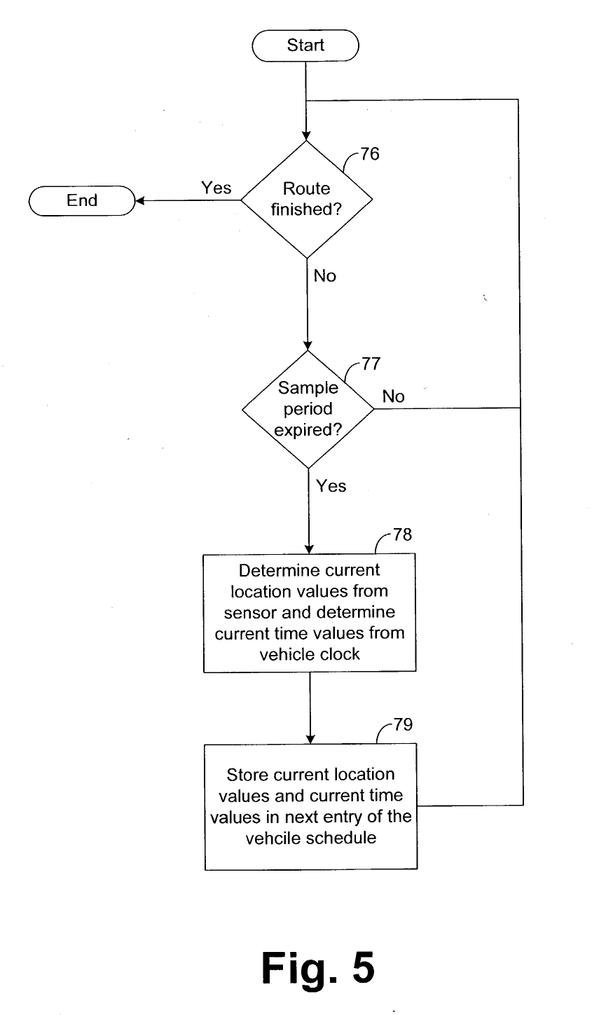

FIG. 5 is a flow chart depicting the operation and functionality of the vehicle manager 29 in embodiments where the vehicle manager 29 determines the vehicle schedule 39a while traveling along the route of travel. As shown by blocks 76 and 77, the vehicle manager 29 determines whether a sample period has expired while the vehicle is traveling on the route (i.e., before the vehicle 17 has finished the route). The sample period is a predetermined amount of time that lapses between samples, which will be discussed in more detail hereinbelow. Preferably, the vehicle clock 38a indicates whether the sample period has expired. For example, when the clock 38a is a counter, the sample period can be defined as a predetermined number of counts by the clock 38a. Therefore, the vehicle manger 29 can determine whether the sample period has expired by counting the number of increments or cycles of the clock 38a.

When the vehicle manager 29 determines that the sample period has expired, the vehicle manager 29 samples the current location values of the vehicle 17 and the time value of the clock 38a. In other words, the vehicle manager 29 determines the current location values of the vehicle 17 and the current time value from the clock 38a and stores these values in the next entry of the vehicle schedule 39a, as depicted by blocks 78 and 79. This process repeats until the vehicle manager 29 determines that the vehicle 17 has completed the route. Thereafter, the vehicle manager 29 can use the vehicle schedule 39a to track the vehicle's progress on future deliveries that utilize the route defined by the vehicle schedule 39a.

Alarm System

Preferably, the vehicle manager 29 is further configured to compare the corresponding entry and the location values supplied from the sensor 18 in order to determine whether an alarm signal should be generated. In this regard, the vehicle manager 29 preferably subtracts the location values in the corresponding entry from the current location values of the vehicle 17 (as determined by the sensor 18) to produce a deviation indicator. Therefore, the deviation indicator indicates how far the vehicle 17 has deviated from the route defined by the vehicle schedule 39a.

The vehicle manager 29 is then designed to compare the deviation indictor to an alarm threshold value to determine whether an alarm signal should be transmitted to the base station manager 41. The alarm threshold value corresponds with the distance that the vehicle 17 can deviate from the predefined vehicle schedule 39a before an alarm is generated. Therefore, if the deviation indicator exceeds the alarm threshold value, the vehicle manager 29 transmits an alarm message to the base station manager 41 via communications devices 44 and 52. Preferably the alarm message includes the current location values produced by the sensor 18 so that the travel of the vehicle 17 can be tracked by the base station manager 41.

Providing an alarm message, as described hereinabove, helps to discover when a vehicle 17 has been stolen or hijacked and helps law enforcement agencies to recover the vehicle 17 by tracking the travel of the vehicle 17 once the vehicle 17 has been stolen. In this regard, the vehicle manager 29 automatically generates an alarm message and monitors travel of the vehicle 17 once the vehicle 17 deviates from the vehicle schedule 39a by a predetermined amount. The alarm message can be used by law enforcement agencies to discover when the vehicle 17 has been stolen and where the vehicle 17 is located, thereby helping law enforcement agencies to recover the vehicle 17 once it has been stolen.

Because the deviation indicator is defined relative to points along the vehicle's route of travel, an alarm can be generated when the vehicle 17 deviates from the route by a relatively small amount. For example, the vehicle manager 29 can be configured to transmit an alarm signal when the vehicle 17 deviates from its predefined route by approximately 20 feet. Other distances, both less than and greater than 20 feet, may be used to trigger an alarm signal. However, it is generally desirable that a certain amount of deviation (depending on the expected driving conditions and the precision of sensor 18) be allowed so that the vehicle 17 can reasonably maneuver through traffic without generating false alarms.

In addition, the alarm threshold value is selectable in the preferred embodiment. This value can be entered into the computer system 31a by a human operator at the vehicle 17 via input device 34a, for example. Alternatively, this value can be communicated from the base station manager 41 to the vehicle manager 29 via communications devices 44 and 52 at or around the start of the route. The alarm threshold value can also be hardwired into the computer system 31a with switches that can be manipulated by a human operator in order to selectively change the value. Many other methodologies known in the art may be used for selecting the value of the alarm threshold value.

It should be noted that in other embodiments, it may be desirable for the vehicle manager 29 to generate an alarm signal based on comparisons of the location of vehicle 17 to a predefined geographical region instead of the route defined in vehicle schedule 39a. For example, it may desirable to define a region that is 30 miles (or some other distance) from the start of the route (or some other particular location). Then, the vehicle manager 29 can be configured to generate an alarm signal if the vehicle manager 29 determines that the vehicle 17 is outside of this predefined region based on the signals 27 received from sensor 18. Such a methodology for generating an alarm signal is particularly suitable for applications where only local deliveries are expected, for example.

There are various methodologies for determining whether the vehicle 17 is outside of the predefined region. For example, in one embodiment, the vehicle manger 29 subtracts the current location values determined from signals 27 with the location values of a particular point (e.g., the location values of the start of the route, when the region is defined as any point within a certain distance of the start of the route) to derive the deviation indicator. As in the preferred embodiment, if the deviation indicator has a magnitude greater than the alarm threshold value, the vehicle manager 29 generates an alarm signal. Otherwise, no alarm signal is generated.

Second Embodiment of the VCU

In a second embodiment of the present invention, the “corresponding entry” of the vehicle schedule 39a is defined as the entry having location values defining a location along the route that was most recently passed by the vehicle 17. Therefore, the vehicle manager 29 monitors the signals 27 from the sensor 18 until the vehicle manager 29 determines that the vehicle passed a location corresponding with one of the entries in the vehicle schedule 39a. The vehicle manager 29 determines whether the vehicle 17 is early or late via the techniques described hereinabove using the aforementioned entry as the corresponding entry.

After determining whether to generate an alarm signal and/or status message for the corresponding entry (and after generating the alarm signal and/or the status message, if necessary), the vehicle manager 29 monitors the signals 27 again for the next corresponding entry. Therefore, when a corresponding entry is detected (i.e., when the vehicle manager 29 determines that the vehicle 17 passed a location corresponding with the location values in one of the entries of the vehicle schedule 39a for the first time), the vehicle manager 29 analyzes the values of the sensor 18, the clock 38a, and the corresponding entry to determine whether an alarm signal and/or status message should be generated. Thereafter, the vehicle manager 29 waits until the next corresponding entry is detected before determining whether to generate another status message. Therefore, the vehicle manager 29 determines whether a status message should be communicated to the base station manager 41 each time the vehicle 17 passes a location corresponding with the location values in one of the entries of the vehicle schedule 39a, and the vehicle manager 29 refrains from communicating status messages as the vehicle 17 travels between locations defined by the data in the vehicle schedule 39a. In other words, the only time the vehicle manager 28 transmits a status message is when the vehicle 17 is passing a location corresponding with one of the entries in the vehicle schedule 39a or a short time thereafter.

However, since it is possible for the vehicle 17 not to pass any of the locations defined in the predefined schedule when the vehicle deviates from the route (e.g., when the vehicle 17 is stolen), the vehicle manager 29 preferably determines whether to communicate an alarm signal periodically rather than waiting for one of the locations defined by the vehicle manager 29 to be passed.

Overall System Operation

A possible implementation of use and operation of the system 10 and associated methodology are described hereafter. For illustrative purposes only, assume that the vehicle 17 is to travel a predetermined route to a destination where the vehicle 17 is to pick up or deliver an item. For example, assume that the vehicle 17 is a bus that is to travel to a bus stop to pick up a passenger and that this passenger is to receive a notification signal when the vehicle 17 is ten minutes from the bus stop.

Initially, the vehicle schedule 39a is stored in the vehicle manager 29 and the base station schedule 39a is stored in the base station manager 41. In the preferred embodiment, the vehicle schedule 39a was created and stored in the vehicle manager 29 as the vehicle 17 previously traveled along the same route. A copy of the vehicle schedule 39a is preferably transferred to the base station manager 41 via any suitable methodology and stored as the base station schedule 39a. For example, the vehicle schedule 39a can be copied to a magnetic disk and later downloaded in memory 30b or a copy of the vehicle schedule 39a can be transmitted to the base station manager 41 via communications devices 44 and 52.

In embodiments where the vehicle schedule 39a is not previously created and stored by the vehicle manager 29, the vehicle schedule 39a is preferably downloaded into both the base station manager 41 and the vehicle manager 29. It is possible to download the base station schedule 39a in the base station manager 41 and to transmit a copy of the base station schedule 39a to the vehicle manager 29 via communications devices 44 and 52 prior to the start of the route. Any methodology for respectively storing the vehicle schedule 39a and the base station schedule 39b into the vehicle manager 29 and the base station manager 41 is suitable for the purposes of the present invention.

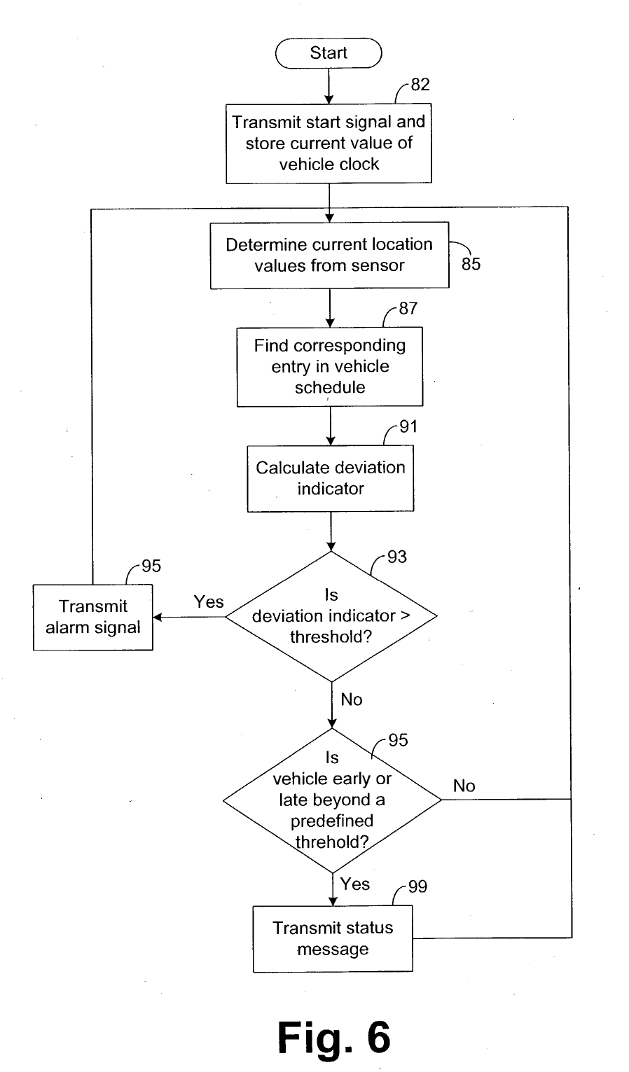

When the vehicle 17 begins travel, the vehicle manager 29 stores the current vlaue of the vehicle clock 38a and begins to monitor the amount of time that lapses from that point until completion of the route. Furthermore, as can be seen by block 82 of FIG. 6, the vehicle manager 29 also transmits a start signal to the base station manger 41 via communications devices 44 and 52 indicating that travel of the vehicle 17 is beginning. In response, the base station manager 41 begins to monitor the lapsed time as well.

In many situations, it may be desirable to begin monitoring travel of the vehicle 17 after the vehicle 17 starts its route. This is particularly true when unpredictable delays usually occur close to the staring point of the route. For example, when the vehicle 17 is a school bus taking children home from school, unpredictable delays may occur close to the starting point (i.e., at the school) where traffic is often congested. Therefore, instead of transmitting a start signal to the base station manager 41 when the vehicle 17 begins traveling, the vehicle manager 29 waits for a predetermined time period or until the vehicle 17 has traveled a predetermined distance from the starting point before transmitting the start signal. For example, the vehicle manager 29 can monitor the travel of the vehicle 17 from the starting point via the sensor 18 and transmit the start signal once the vehicle manager 29 determines that the vehicle has traveled one-eighth of a mile from the starting point. In this regard, location values representing a predetermined point along the route of travel and one-eighth of a mile from the starting point can be stored in the vehicle manager 29. When the vehicle manager 29 determines that the vehicle 17 passes this point, the vehicle manager 29 determines that the vehicle 29 has traveled more than one-eighth of a mile and transmits the start signal.

Preferably, the predetermined schedules 39a and 39b both use the point where the vehicle manager 29 transmits the start signal as the starting point for the route. Therefore, the distances and times stored in the predetermined schedules 39a and 39b are relative to the predetermined location where vehicle manager 29 transmits the start signal instead of the actual starting point of the route. However, this is not a necessary feature of the present invention, and the location values and time values stored in the predetermined schedules 39a and 39b may be relative to other points both along the route of travel and outside of the route of travel.

As the vehicle 17 travels, GPS satellites 23 transmit wireless signals 21 to sensor 18 that can be analyzed through techniques well known in the art to determine a position (i.e., current location values) of the sensor 18 (and, therefore, of the vehicle 17) relative to a particular reference point, as depicted by block 85 of FIG. 6. F or example, in GPS systems, the intersection of the Equator and the Prime Meridian is typically used as the reference point. Sensor 18 receives the signals 21 and determines location values representing the position of the vehicle 17 relative to the reference point and transmits these values to vehicle manager 29.

The vehicle manager 29 compares the current location values of the vehicle 17 with the location values in the vehicle schedule 39a in order to determine which entry in the vehicle schedule 39a corresponds with the current location of the vehicle 17, as shown by block 87 of FIG. 6. The corresponding entry is preferably the entry having location values that most closely match the current location values received from the sensor 18.

After selecting the corresponding entry, the vehicle manager 29 retrieves the location values associated with the corresponding entry and subtracts these values from the current location values received from the sensor 18 and used by the vehicle manager 29 to select the corresponding entry. Referring to block 91 of FIG. 6, the resulting value or values (referred to as the deviation indicator) indicates the vehicle's deviation from the vehicle schedule 39a. As shown by block 93 of FIG. 6, the vehicle manager 29 then compares the deviation indicator to the alarm threshold value. If the deviation indicator exceeds the alarm threshold value, then the vehicle manager 29 transmits an alarm message to the base station manager 41, as depicted by block 95 of FIG. 6. The alarm message includes the current location of the vehicle 18, and the base station manager 41 tracks the location of the vehicle 17 based on the alarm messages transmitted from the vehicle manager 29. The information provided by the alarm message can be used by law enforcement agencies to track the vehicle 18.

After determining whether an alarm message should be generated, the vehicle manager 29 retrieves the time value associated with the corresponding entry and compares it with the time value indicated by clock 38a (i.e., the time value indicating the amount of time elapsed since the start of the route). The vehicle manager 29 also retrieves a predetermined threshold value indicating how much the vehicle 17 can deviate from the vehicle predefined schedule 39a before the vehicle 17 is considered to be off schedule. Referring to block 97 of FIG. 6, if the difference of the foregoing time values exceeds the predetermined threshold value, then the vehicle manager 29 determines that the vehicle 17 is off schedule. However, if the difference of the foregoing time values is less than the predetermined threshold value, then the vehicle manager 29 determines that the vehicle 17 is on schedule.

When the vehicle manager 29 determines that the vehicle 17 is on schedule, the vehicle manager takes no further action regarding the current location values received from the sensor 18. The vehicle manager 29 merely receives a new set of location values from the sensor 18 and analyzes the new set of values according to the methodology described herein. However, when the vehicle manager 29 determines that the vehicle 17 is off schedule, the vehicle manager 29 generates a status message and transmits the status message to the base station manager 41, as depicted by block 99 of FIG. 6.

In this regard, the vehicle manager 29 determines whether the vehicle 17 is early or late and how far the vehicle 17 is off schedule (e.g., how many minutes or miles the vehicle 17 is from the location specified by the location values in the corresponding entry). The vehicle manager 29 then generates a status message including this information and transmits the status message to the base station manager 41 via communications devices 44 and 52.

In order to reduce the number of transmissions between the vehicle 17 and the base station control unit 40, the vehicle manager 29 preferably (although not necessary) transmits the status message to the base station manager 41 only if another status message has not been transmitted within a predetermined delay period. For example, if a status message has been sent within a predetermined time period, for example, within the last five minutes, then the vehicle manager 29 refrains from sending another status message. It should be apparent to one skilled in the art that other delay periods can be selected to update the location of the vehicle 17 at a desirable rate.

Furthermore, it is possible to selectively control the delay period. For example, when the vehicle 17 stops to make a delivery or is slowly traveling through congested areas, it may be desirable to increase the delay period to decrease the number of status messages sent to the base station manager 41. Alternatively, when the vehicle 17 is traveling quickly and the location of the vehicle 17 is changing rapidly, it may be desirable to decrease the delay period. Furthermore, when the vehicle 17 enters an area where no immediate deliveries or pick ups are to made, there is no immediate need to monitor the vehicle 17 and the delay period can be increased. The delay periods can be predefined in memory 30a, can be controlled by the operator of the vehicle 17, or can be controlled via signals transmitted from remote locations to the vehicle manager 29 (e.g., from the base station manager 41 to the vehicle manager 29 via communications device 44). Other methodologies for controlling the delay periods are possible.

Another way to reduce the number of transmissions of status messages at desired times is to selectively increase the predefined amount that the vehicle 17 should be off schedule before a status message is transmitted to the base station control manager 41. Similar to the changes in the delay periods described above, the changes to the aforementioned predefined amount can be predefined in memory 30a, can be controlled by the operator of the vehicle 17, or can be controlled via signals transmitted from remote locations to the vehicle manager 29 (e.g., from base station manager 41 to vehicle manager 29 via communications device 44).

The input device 34a (FIG. 3) can be used to input changes in the delay period and/or in the predefined amount that the vehicle should be off schedule before a status message is transmitted. In this regard, the input device 34 a may include switches, buttons, a key pad, or any other device that can be manipulated by the operator of the vehicle 17 to input the changes.

When the base station manager 41 receives a status message, the base station manager 41 stores the status message in memory 30b. If desired, the base station manager 41 transmits a message to the user via communications devices 72 and 73 indicating that the vehicle 17 is off schedule and indicating how much the vehicle 17 is off schedule in response to the status message.

The base station manager 41 periodically determines whether a notification message should be sent to the user indicating that arrival of the vehicle 17 at the bus stop is imminent (e.g., indicating that the vehicle 17 is ten minutes from the bus stop). In this regard, the notification message should be sent to the user when the vehicle 17 is within a predetermined proximity (i.e., a predetermined time or distance) from the bus stop. To determine whether the notification message should be sent, the base station manager 41 compares the location values of the current location of the vehicle 17 to the location values of the predetermined location (e.g., the bus stop). If the difference between the location values of the current location of the vehicle 17 and the bus stop is greater than a threshold value, then the vehicle 17 is too far from the bus stop for notification to be sent to the user. Therefore, a notification message is not generated. However, if the difference between the location values of the current location of the vehicle 17 and the bus stop is less than the threshold value, then a notification message is transmitted to the user via communications devices 72 and 73, unless a similar notification message (i.e., a message indicating that the vehicle 17 is off schedule by the same amount) associated with the bus stop has previously been sent to the user.

In determining the current location of the vehicle 17, the base station manager 41 assumes that the vehicle 17 is on schedule unless a recent status message has been received. Therefore, the vehicle manager 41 determines which entry in the base station schedule 39b corresponds to the assumed location of the vehicle 17. In this regard, the vehicle manager 41 compares the time values in the base station schedule 39b with a lapsed time value indicating how much time has lapsed since the vehicle 17 started the route. The entry having a time value closest to this lapsed time value is the corresponding entry. The location values associated with the corresponding entry represent the assumed location of the vehicle 17. Unless a recent status message has been received, the base station manager 41 uses these location values as the current location values to be compared against the location values of the predetermined location (e.g., the bus stop) in order to determine whether a notification message should be sent to the user. However, if a recent status message has been received, then the base station manager 41 determines the current location values of the vehicle 17 based on the recent status message and/or the location values associated with the corresponding entry.

For example, if the recent status message includes location values indicating the actual location of the vehicle 17, then the base station manager 41 uses these values to compare with the coordinate values of the predetermined location (e.g., the bus stop). However, if the status message only indicates how much the vehicle 17 is off schedule, then the base station manager 41 calculates the current location values of the vehicle 17 based on the status message and the location values associated with the corresponding entry in the base station schedule 39b.

Once the current location values of the vehicle 17 have been determined, the base station manager 41 compares the current location values of the vehicle 17 with the location values of the predetermined location (e.g., the bus stop) as previously described hereinabove to determine whether a notification signal should be transmitted to the user.

The operation of the preferred embodiment has been described hereinabove in the context where the vehicle manager 29 compares location values to determine the corresponding entry in the vehicle predefined schedule 39a. Therefore, the vehicle manager 29 compares the time value associated with the corresponding entry in the vehicle schedule 39a to determine whether or not the vehicle 17 is on schedule. However, it should be apparent to one skilled in the art upon reading this disclosure that time values may be compared by the vehicle manager 29 to determine the corresponding entry in the vehicle predefined schedule 39a.

In this regard, the entry in the vehicle schedule 39a having a time value most closely matching the lapsed time value indicated by the clock 38a (i.e., the value indicating the amount of time lapsed since the start of the route) can be selected as the corresponding entry. As a result, the vehicle manager 29 determines how far the vehicle 17 is off schedule based on distance rather than time. For example, if the difference between the current location values of the vehicle 17 (as determined by the sensor 18) and the location values associated with the corresponding entry is greater than a predetermined threshold value, then the vehicle 17 is off schedule. Otherwise, the vehicle 17 is on schedule. Furthermore, regardless of which embodiment is used to determine how far the vehicle 17 is off schedule, the vehicle manager 29 can indicate how far the vehicle 17 is off schedule via the status message using either distance values, time values, or any other type of values known in the art for indicating the position of the vehicle 17.

It should be noted that the preferred embodiment has been described hereinabove assuming that the sensor 18 is capable of determining the vehicle's location based on signals received from satellites 23. However, this is not a necessary feature, and any type of sensor 18 that may be used for determining the vehicle's position along the route of travel is sufficient for the purposes of the present invention. For example, the sensor 18 may be designed as an odometer that indicates how far the vehicle 17 travels. Therefore, the predetermined points along the route of travel used to determine whether the vehicle 17 is on or off schedule can be defined in the schedules 39a and 39b relative to their distance from the starting point of the route. In other words, the location values stored in the schedules 39a and 39b correspond to distance values indicating how far the predetermined points are from the starting point of the route. Therefore, the vehicle manager 29 can determine how far the vehicle 29 is from any of the predetermined points by determining how far the vehicle 17 has traveled from the starting point of the route.

User-Definable Communications Methods/Systems

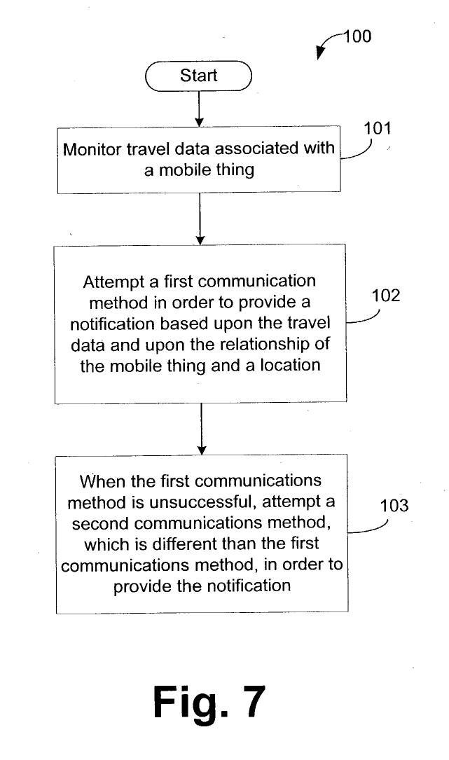

The present invention provides user-definable communications methods and systems that can be used in connection with an advance notification system. Nonlimiting examples of implementations are shown and described in connection with FIGS. 7 through 10. Although not limited to these implementations, in the preferred embodiments, the user-definable methods and systems are implemented by the base station manager 41 (FIG. 1) associated with the BSCU 40 (FIG. 1). Also note that much, if not all, of the subject matter of these methods and systems are disclosed in the inventor's prior application Ser. No. 08/852,119, filed May 6, 1997, which claims priority to provisional application Ser. No. 60/039,925, filed Mar. 7, 1997, both of which are incorporated herein by reference in their entirety.

One such user-definable communications method, among others, is shown in FIG. 7 and denoted by reference numeral 100. The method 100 can be broadly and succinctly summarized by the following steps: monitoring travel data associated with a mobile thing (block 101); attempting a first communications method in order to provide a notification based upon the travel data and upon the relationship of the mobile thing and a location (block 102); and when the first communications method attempt is unsuccessful, attempting one or more other communications methods (while ceasing or continuing to attempt the first communications method), which are different than the first communications method, in order to provide the notification (block 103). The software associated with the base station manager 41 (FIG. 1) would implement the foregoing steps.

The communications methods may involve, for example but not limited to, communicating a signal and/or a message to a land-line telephone, cellular, satellite, or wireless telephone, facsimile machine, computer, television, cable TV transceiver, satellite transceiver, personal data assistant (PDA), pager, any addressable communications device on the internet, etc. Both a signal and a message may be sent to the target communications device, for example, a ring signal and a text message could be communicated to a PDA, pager, or computer.

The first and second communications methods of the method/system 100 may be directed to the same device or same type of device, for example but not limited to, a telephone, or the communications methods may be directed to different types of devices, for example but not limited to, (a) a telephone (first communications method) and a pager (second communications method) or (b) a pager (first communications method) and a computer (second communications method) configured to communicate email. A determination as to whether the first communications method is “unsuccessful” by the base station manager 41 can be made in a number of ways, for example but not limited to, whether a predetermined time period expires without a connection or without a responsive signal at the far end, whether a busy signal is received when attempting to contact a telephone, whether a preset number of rings occurs without a connection, whether a facsimile tone is received from the far end, etc.

When or after the software associated with the method/system 100 determines that a notification should be made, based upon monitoring the travel status in relation to the desired location, the communications methods can be determined, or identified, in the software by comparing a current time value with one or more preset time periods associated with one or more communications methods. During the comparison process, one or more of the communication methods are selected.

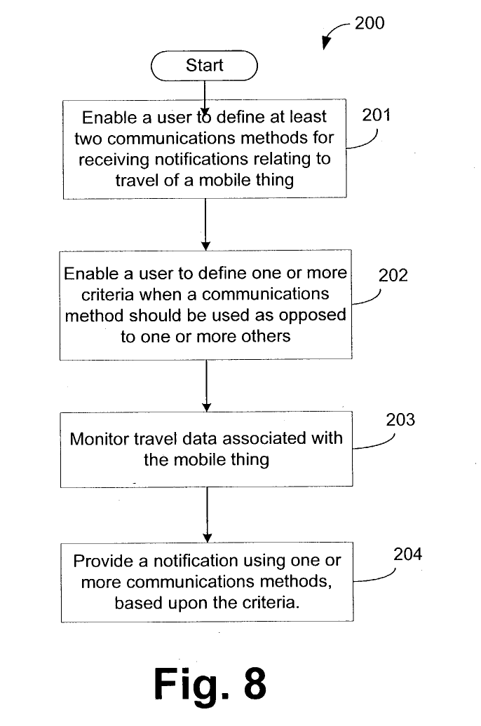

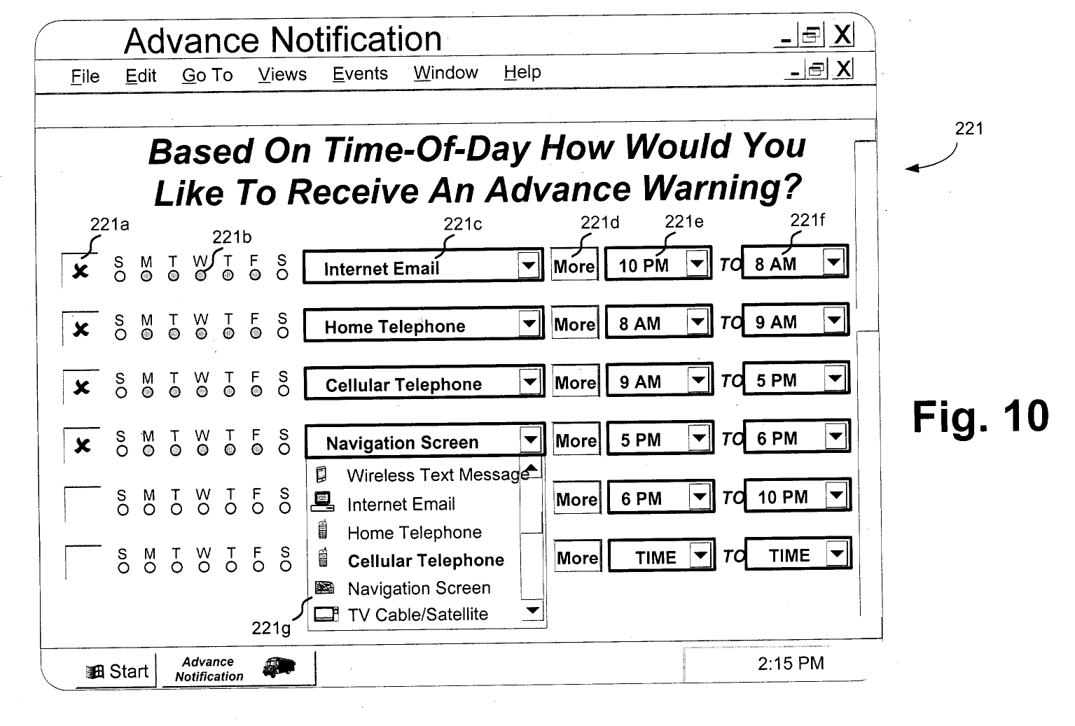

As an optional feature, the software may be configured to enable a party to proactively define the aforementioned one or more time periods (e.g., time periods in a day, which days of the week, etc.) for use of each of the communications methods. In this embodiment, the user selections can be stored in a user notification preferences database, which can be accessed by the software when appropriate. For instance, a party can indicate that notifications can be made to the party's telephone between the hours of 6:00 pm and 11:00 pm. This can be accomplished by having the party contact the base station manager 41 and provide the information. An interface to the base station manager 41 can be provided, for example, over a standard telephone using suitable automated voice recognition (AVR) software, which is commercially available, or as another example, via a web page over the internet, which will be described later hereinafter in connection with FIGS. 8 and 10.

As a further optional feature, the software can be designed to enable a party to proactively define the two or more of the communications methods for receiving notifications relating to travel of the mobile thing. This can be accomplished by having the party contact the base station manager 41 and provide the information. An interface to the base station manager 41 can be provided, for example, over a standard telephone using suitable automated voice recognition (AVR) software, which is commercially available, or as another example, via a web page over the internet, which will be described later hereinafter in connection with FIGS. 8 and 10.

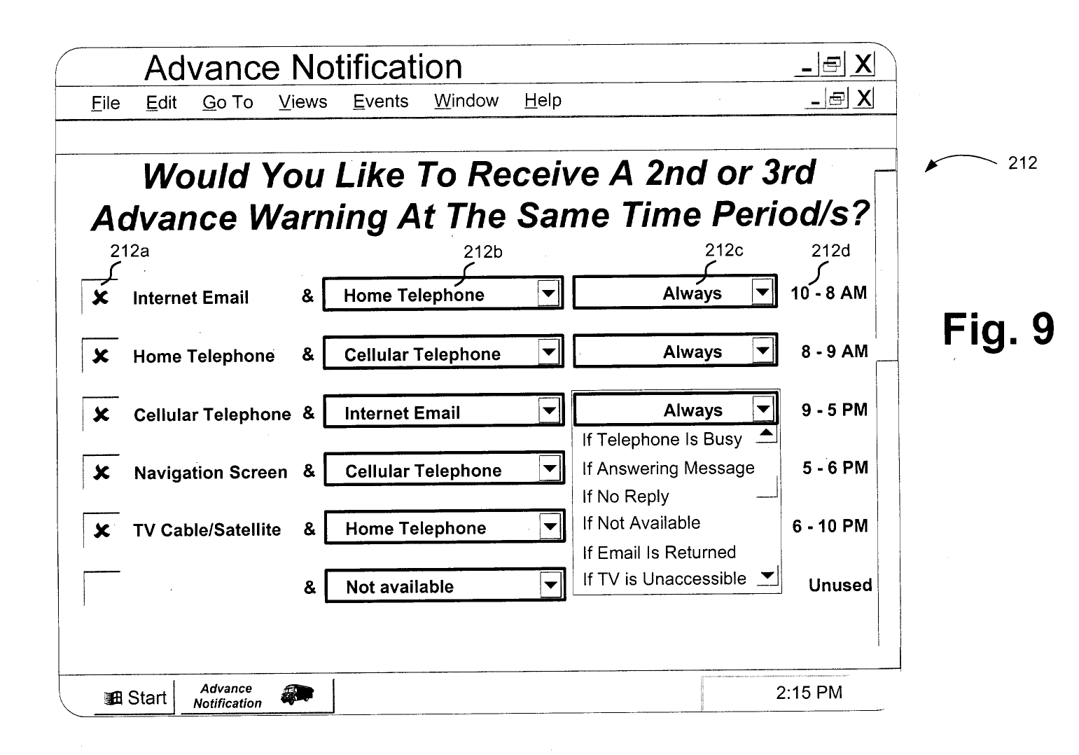

Another user-definable communications method of the present invention, among others, is illustrated in FIG. 9 and generally denoted by reference numeral 200. The method 200 can be broadly summarized by the following steps (not required to be performed in the order presented; obviously, the first three can be in any order): enabling a user to define at least two communications methods for receiving notifications relating to travel of a mobile thing (block 201); enabling a user to define one or more criteria when a communications method should be used as opposed to one or more others (block 202); monitoring travel data associated with the mobile thing (block 203); and providing a notification using one of the communications methods, based upon the criteria (block 204). The software associated with the base station manager 41 (FIG. 1) would implement the foregoing steps.

In such a method/system 200, as a further optional feature, the communications methods may utilize the same or the same type of device, for example but not limited to, a telephone, or they may use different types of communications devices, for example but not limited to, (a) a telephone (first communications method) and a pager (second communications method) or (b) a pager (first communications method) and a computer (second communications method) configured to communicate email.

In such a method/system 200, as a further optional feature, at least one criterion of the criteria may be a time period or periods (e.g., time periods in a day, which days of the week, etc.) when the communications method should be utilized.

In such a method/system 200, as a further optional feature, more than one communications method may be used concurrently.

FIG. 9 shows a computer screen 212 that can be generated and provided to a user to enable practice of the methods/systems 100, 200 and allow a user to define user preferences over the internet using, for example, the world wide web. A web server can be interfaced with the BSCU 40 and the base station manager 41 to provide the interface between the BSCU 40 and the internet, or as another exemplary alternative, web server functionality can be built into the BSCU 40 and manager 41. As illustrated in FIG. 9, the screen 212 enables a user to specify, on each horizontal line, one or two communications methods for a particular time period of each day. As shown at reference numeral 212a, the user can indicate and input the one or more communications methods that should be utilized. As illustrated in FIG. 9, as an example, “Internet Email” has been selected (see “x”) by the user for the time period “10-8 AM” (i.e., 10 PM to 8 AM).

In window 212b, the user can indicate a second communications method that should be used. As indicated by the drop-down arrow, a suitable drop-down menu can be provided to enable easy selection by the user. As indicated by reference numeral 212c, the user can specify when the second communications method should be utilized. Examples are shown in FIG. 8 as part of a drop-down menu for window 212c.

One such example is “Always.” When this is selected, the second communications method will be utilized always when the first communications method is utilized. As another example, if (a) the first communications method is marked by one of boxes 212a is a “Home Telephone,” (b) the second communications method denoted at window 212b is “Internet Email,” (c) the preference at window 212c is “If Telephone Is Busy,” (d) the preference at window 212d is “8-9 AM,” and (e) a notification should be made by the manager 41 during this time period, then (f) the base station manager 41 will contact the home telephone first and if it is busy, then it will send a notification via internet email. There are numerous other possibilities, based upon the options that are available, but all will not be described here for brevity.

Other screens can be provided to the user to enable the user to identify and input necessary communications information associated with the communications devices or methods, such as an email address (if that option is selected) or a telephone number (if that option is selected). The user could also be prompted to build profiles associated with the communications devices or methods, at any point before, during, or after communication of the screen 112 in FIG. 8.

FIG. 10 shows another nonlimiting example of a computer screen 221 that can be provided by the base station manager 41 to the user to enable practice of the methods/systems 100, 200 and enable a user to define user preferences. In this embodiment, one or more communications methods can be selected and the user can select days of the week and time periods for each communications method. In blocks 221a, a user can select one or more communications devices 75 or methods to be utilized. In region 221b, the user can select one or more days of the week for the communications method. In window 221c, the user can indicate a communications method that should be utilized. Examples are shown in FIG. 10 as part of a drop-down menu 221g for window 221c: wireless text message, internet email, home telephone, cellular telephone, navigation screen, TV cable/satellite (i.e., receipt by TV via cable or satellite), etc. In blocks 221e and 221f, the user can specify starting and ending times, respectively, when the communications method should be utilized. A “More” button 221d can be used to provide a drop-down menu to the user for making time entries easier.

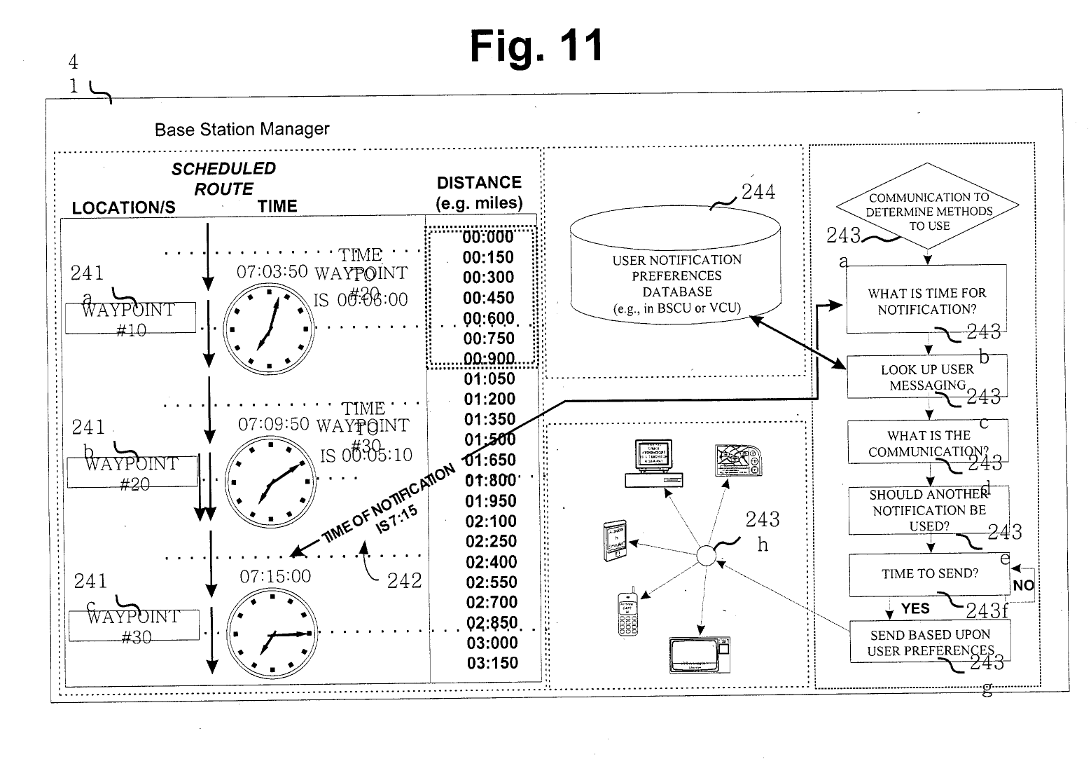

FIG. 11 is a flow chart illustrating an exemplary implementation of at least part of the architecture, functionality, and operation of the of the manager 14 of the base station manager of FIG. 1 for implementing yet another user-definable communications method and system. As shown in FIG. 11, the method/system is generally denoted by reference numeral 240 and can be broadly summarized by steps 243a-243g. In the method/system 240, travel of a mobile vehicle is monitored via way points 241a-241c, distance into route, and a determination as to the actual activation point 242 of a notification and/or notification message. Furthermore, the method/system 240 is designed to determine the activation point based upon a predefined time period, prior to a notification message being sent to a user, to look up user notification preferences in database 244 for receiving notifications, and to send an arrival notification and/or notification message based on system-defined or user-defined preferences.

Methods of Doing Business In Connection with Notification Services

Various methods of doing business can be implemented in connection with the notification services described herein.

One such method of doing business, among others, can be broadly summarized by the following steps: offering a notification service regarding status of travel of a movable thing relative to a location; accepting a fee in exchange for the notification service; monitoring travel data associated with said movable thing; and providing a notification based upon a particular proximity of said movable thing to said location.

More specifically, as a nonlimiting example, consider this methodology in the context of a telephone company. It may be desirable for a telephone company (or other entity) to provide the notification services of the BSCU 40 and to allow many different customers to subscribe for the services of the BSCU 40. In this regard, each customer can acquire a VCU 15 and can contact the telephone company (or other entity providing the services of the BSCU 40) to request the services of the BSCU 40. In exchange for the payment of a subscription fee, the services of the BSCU 40 can be provided to the customer. When the entity providing the services of the BSCU 40 is a telephone company, the telephone company can include the bill of the subscription fee in the customer's telephone bill. For example, a customer usually receives a telephone bill from the telephone company in exchange for the capability of utilizing the PSTN 55 or other networks. The subscription fee for providing the services of the BSCU 10 can be included in this telephone bill.

After establishing the subscription, the customer is preferably allowed to establish when he or she would like to be notified of an impending arrival of a vehicle 17. For example, the customer may be allowed to establish communication with the base station manager 41 (either directly via a telephone call and touch tone signaling, for example, or indirectly via an operator interfaced with the base station manager 41) and to identify the vehicle 17 or VCU 15 to be monitored and the predetermined location that should be used to determine when a notification message is transmitted to the customer. Alternatively, the customer may be allowed to provide a time period or distance that the identified vehicle 17 or VCU 15 should be from a particular location (e.g., a scheduled vehicle stop) before a notification message is transmitted. In response, the base station manager 41 is designed to determine the location values of the predetermined location (if the location values are not already provided by the customer) and to store the location values in memory 30b (FIG. 4). Then, the services of the BSCU 40 may be provided to the customer via the techniques described herein.

In addition, the customer may be allowed to obtain a status report as a service of the BSCU 40. In this regard, the customer may be allowed to establish communications with the base station manager 41 either directly or indirectly and to request a status report for a particular vehicle 17. In response, the base station manager 41 is designed to determine the current location of the vehicle 17 according to the techniques described hereinabove and to transmit information (e.g., the location of the vehicle 17, the distance the vehicle 17 is from a particular location, or the time the vehicle 17 is from a particular location etc.) indicating the proximity of the vehicle 17. A system allowing a customer to establish the parameters used by the base station manager 41 to monitor the vehicle 17 and to request status reports is fully described in U.S. patent application entitled “System and Method for Activation of an Advance Notification System for Monitoring and Reporting Status of Vehicle Travel,” assigned Ser. No. 09/163,588 and filed on Sep. 30, 1998, which is incorporated herein by reference.

Another possible method of doing business can be broadly summarized or conceptualized by the following steps: offering to a user a notification service regarding status of travel of a movable thing relative to a location; charging a fee to the user in exchange for the notification service; and in accordance with the notification service: (a) enabling the user to define at least two communications methods for receiving notifications relating to travel of a mobile thing; (b) enabling the user to define one or more criteria when each of the communications methods should be used as opposed to the one or more others; (c) monitoring travel data associated with the movable thing; and (d) providing a notification to the user using at least one of the communications methods based upon a particular proximity of the movable thing to the location and the one or more criteria.

There are various alternatives and optional features that may be practiced in connection with this method. For example, the fee may be added on to a fee for a travel or shipment service. As another example, a fee may be charged for each notification, for a block of notifications, and for the service in general. As yet another example, a discount on the notification service may be offered based upon a purchase of a predetermined number of notifications.

Another possible method of doing business can be broadly summarized or conceptualized by the following steps: offering a notification service regarding status of travel of a movable thing relative to a location; charging a fee in exchange for the notification service; in accordance with the notification service: (a) monitoring travel data associated with the mobile thing; (b) determining that a notification should be made, based upon the travel data and upon the relationship of the mobile thing to the location; (c) comparing a current time value with one or more preset time periods associated with one or more communications methods; (d) selecting one or more of the communication methods based upon the comparing step; and (e) providing the notification using the one or more communications methods.

There are various alternatives and optional features that may be practiced in connection with this method. For example, the fee may be added on to a fee for a travel or shipment service. As another example, a fee may be charged for each notification, a block of notifications, or for the service in general. As yet another example, a discount on the notification service may be offered or extended based upon a purchase of a predetermined number of notifications.

### CONCLUSION

In concluding the detailed description, it should be noted that the terminology “preferred embodiment” herein means the one embodiment currently believed by the inventor(s) to be the best embodiment of a plurality of possible embodiments. Moreover, it will be obvious to those skilled in the art that many variations and modifications may be made to the preferred embodiment(s) without substantially departing from the principles of the present invention. All such variations and modifications are intended to be included herein within the teachings of the present invention in this document and to be protected by the scope of the following claims.

As an example of a variation, it is possible to implement the user-definable communications methods and systems in a system where notifications are made from the moving thing itself (those systems that do not utilize a BSCU 40 to implement the notifications). One such system is described in U.S. Pat. No. 5,444,444, which is incorporated herein by reference.

As another example, the VCU 15 and/or the BSCU 40, each or both, can be a distributed system, comprising more than one computer.

As another example, the base station manager 41 can be a distributed system, comprising one or more software modules operating on one or more computers.

As another example, the base station manager 41 can be designed to notify the user when receiving notice that a mobile thing's schedule has been changed or the mobile thing's stop at a location has been cancelled, as opposed to waiting on tracking information to determine delay in arrival or departure of the mobile thing. This information could be input manually by a person or it could come from another computer system. The software associated with the base station manager 41 could also be configured to enable a user to configure the system so that the user is notified upon a change and/or cancellation.

Therefore, at least the following is claimed:

1. A method of doing business, comprising:
offering to a user a notification service regarding status of travel of a movable thing relative to a location;
charging a fee to the user in exchange for the notification service;
in accordance with the notification service:
enabling the user to define at least two communications methods for receiving notifications relating to travel of a mobile thing;
enabling the user to define one or more criteria when each of the communications methods should be used as opposed to the one or more others;
monitoring travel data associated with the movable thing; and
providing a notification to the user using at least one of the communications methods based upon a particular proximity of the movable thing to the location and the one or more criteria.

2. The method of claim 1, wherein the fee is added on to a fee for a travel or shipment service.

3. The method of claim 1, further comprising the step of charging a fee for each notification.

4. The method of claim 1, further comprising the step of providing a discount on the notification service based upon a purchase of a predetermined number of notifications.

5. A method of doing business, comprising:
offering a notification service regarding status of travel of a movable thing relative to a location;
charging a fee in exchange for the notification service;
in accordance with the notification service:
monitoring travel data associated with the mobile thing;
determining that a notification should be made, based upon the travel data and upon the relationship of the mobile thing to the location;
comparing a current time value with one or more preset time periods associated with one or more communications methods;
selecting one or more of the communication methods based upon the comparing step; and
providing the notification using the one or more communications methods.

6. The method of claim 5, wherein the fee is added on to a fee for a travel or shipment service.

7. The method of claim 5, further comprising the step of charging a fee for each notification.

8. The method of claim 5, further comprising the step of providing a discount on the notification service based upon a purchase of a predetermined number of notifications.
